(19) United States
(12) Patent Application Publication
(10) Pub. No.: US 2020/0019230 A1
(43) Pub. Date: Jan. 16, 2020

(54) MANAGING POWER CONSUMPTIONS OF MULTIPLE COMPUTING NODES IN A HYPER-CONVERGED COMPUTING SYSTEM

(71) Applicant: NUTANIX, INC., San Jose, CA (US)

(72) Inventors: Yao Rong, San Jose, CA (US); Purushotham G. Lala Balaji, San Jose, CA (US); Alay Vyomeshbhai Shah, San Jose, CA (US); Varinder Kumar Sogi, Fremont, CA (US)

(73) Assignee: NUTANIX, INC., San Jose, CA (US)

(21) Appl. No.: 16/031,366

(22) Filed: Jul. 10, 2018

(51) Int. Cl. G06F 1/32; G06F 9/455

(52) U.S. Cl. CPC G06F 1/3296; G06F 1/3209; G06F 2009/45591; G06F 2009/45595; G06F 9/45558

(57) ABSTRACT

A hyper-converged computing system may include multiple computing nodes and a power management system. Each computing node may have a processor operating at a power state. Each computing node may receive a power budget from the power management system, determine an instant power consumption in the node and determine whether the instant power consumption is approaching the power budget. If the instant power consumption is approaching the power budget, the computing node may adjust the power consumption of the node. The power management system may determine an initial power budget rule for each computing node and transmit the initial power budget rule to each respective computing node. The power management system may also obtain various provisioning and status from the multiple computing nodes and use the provisioning and status to update the power budget rules for each respective computing node.

### TECHNICAL FIELD

This disclosure is related to power management systems. Examples of managing power consumption of multiple computing nodes in a hyper-converged system are described.

### BACKGROUND

In a hyper-converged system, such as a hyper-converged data center, a primary electricity distribution switch supplies power to various uninterrupted power systems (UPS). Each UPS will then supply power to power distribution units (PDUs) on server racks. Power outage may occur when the power consumption of the servers exceeds the limit of the circuit breaker on the primary switch board, UPS or PDU. This is because data center operators usually over-allocate server power budget to save rack room cost, equipment lease cost, etc. This over-allocation of power budget is usually based on the assumption that all of the servers on the same rack will not reach the maximum power simultaneously. For example, a server block power rating may be at 2000 w, with about 20 A max in current. If a rack is equipped with two PDUs, each having 24 A rating, then each rack can only deploy 5 blocks of servers based on the max current limitation. In practice, because it would be rare for all the servers in the same rack to consume their maximum power at the same time, most data center operators deploy more than five server blocks in this case. This may create the risk of power consumption spike, which causes PDU/UPS/circuit breaker to trip. When that happens, all of the blocks on the same PDU may go down. Some existing systems use redundancy in power systems, for example, double the power supplies. However, this can be costly.

### BRIEF DESCRIPTION OF THE DRAWINGS

FIG. 1 is a block diagram of a computing system in accordance with examples described herein.

FIG. 2 is a diagram of an example of a process implemented in a computing node in accordance with examples described herein.

FIG. 3 is a diagram of an example of a process implemented in a power management system in accordance with examples described herein.

FIG. 4 is a block diagram of a hyper-converged computing system implementing various embodiments in accordance with examples described herein.

FIG. 5 is a block diagram of components of a computing node or power management system in accordance with examples described herein.

### DETAILED DESCRIPTIONS

Certain details are set forth herein to provide an understanding of described embodiments of technology. However, other examples may be practiced without various of these particular details to avoid unnecessarily obscuring the described embodiments. Other embodiments may be utilized, and other changes may be made, without departing from the spirit or scope of the subject matter presented here.

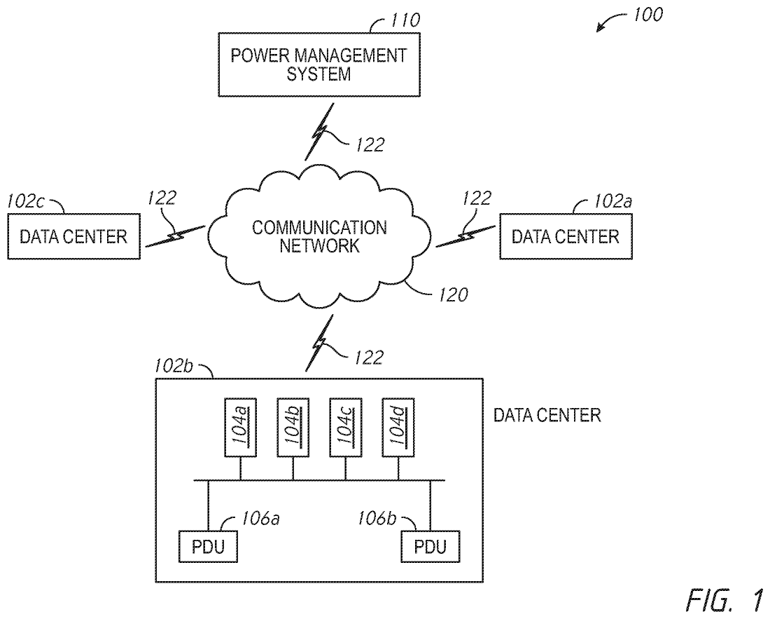

In FIG. 1, a computing network system 100 may include one or more data centers 102a, 102b, 102c. Each of the data centers, such as data center 102b, may include one or more computer nodes 104a-104d. Each computing node may include a server, such as a web server, a database server, or an application server. Each computing node may also include any computing device, for example, a server on the cloud, or a virtual machine. Each computing node 104a-104d may be connected to one or more PDUs 106a, 106b and draw power thereof. For example, data center 102b may include one or more rows of servers 104a-104d that are powered by one or more PDUs 106a, 106b. In some scenarios, each PDU 106a, 106b may have a maximum power limit, such as 24 amps. In this case, the aggregated power at any instant time that are drawn from all of the servers connected to that PDU may not exceed the maximum power limit of that PDU. In some scenarios, each data center 102a-102c may be in communication with a communication network 120. In some examples, each computing node 104a-104d in the data center 102b may be in communication with the communication network 120. In some examples, each PDU 106a, 106b may also be in communication with the communication network 120.

Computing system 100 may also include a power management system 110 that is in communication with the communication network 120. In some scenarios, the power management system 110 and the one or more data centers 102a-102d may communicate with each other via the communication network 120 through one or more communication links 122. The communication network 120 may be a local area network (LAN), wide area network (WAN), intranet, Internet, or a combination thereof. Communication link 122 may be a wired, a wireless network, or a combination thereof. For example, each or at least one or more computing nodes 104a-104d may be connected to the communication network via an Ethernet link. In other examples, a PDU, e.g., 106a, may be in communication with the communication network 120 wirelessly.

In some scenarios, power management system 110 may be configured to determine a respective power budget rule for each of the multiple computing nodes. The power budget rule may include a power budget. For example, a power budget may include a maximum current for which the computer node may run, e.g., 10 A or 1000 watts. In some scenarios, the power budget may correspond to the maximum limit of each PDU. For example, data center 102b has two PDUs, each may have a limit of 24 A. A power budget for each computing node may be 48 A, or 24 A, or other variations. In some examples, the power budget for each computing node may vary depending on the power consumption pattern among multiple computing nodes in the data center, and/or the priority of workloads for each computing node. In some scenarios, the power budget in a power budget rule may be represented by one or more data blocks that are stored in a memory or storage of one or more computing nodes. For example, a budget rule that has a power budget of 1000 watts may be represented by a 16-bit data block.

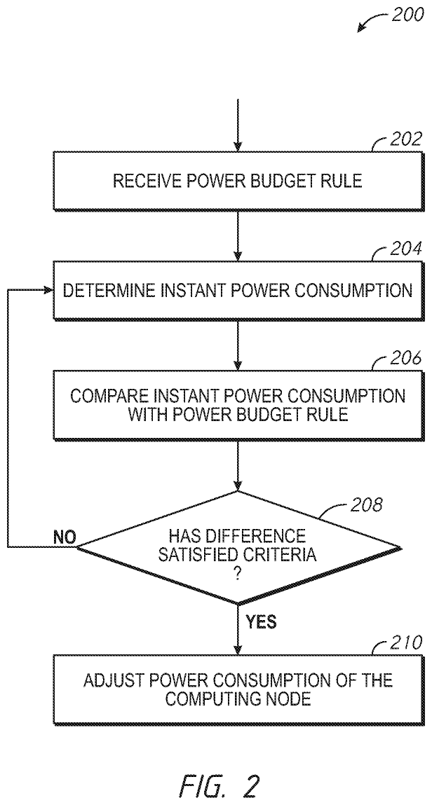

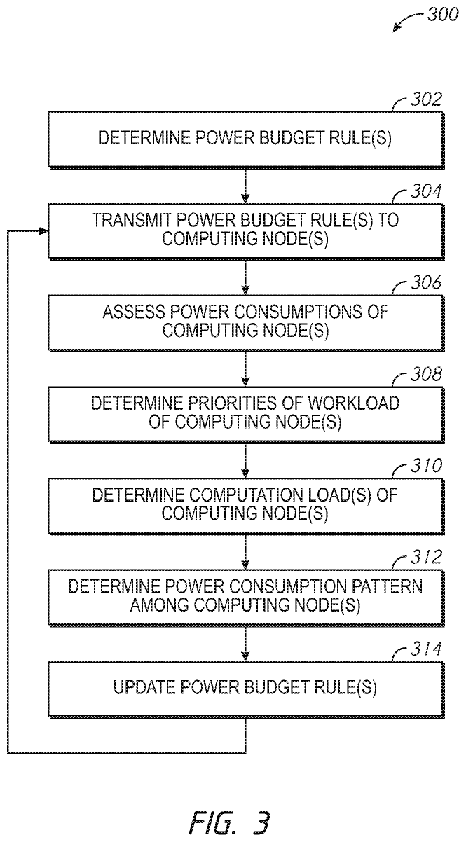

With continued reference to FIG. 1, power management system 110 may transmit the respective power budget rules to one or more computing nodes. For example, the power budget rule may be transmitted from the power management 110 to one or more computing nodes in a data packet which includes the data block representing the power budget. Each computing node, e.g., 104a-104d, may be configured to receive the respective power budget rule for that computing node, store the power budget rule in a storage, e.g., a local storage of that computing node. Each computing node may adjust power consumption of that computing node by comparing an instant power consumption with the power budget in the power budget rule. For example, the computing node may be coupled to a power meter that measures instant power consumption of the computing node. The computing node may be configured to determine the instant power consumption of the computing node measured by the power meter and store the instant power consumption in a local storage. In some scenarios, the power meter may be configured to generate an analog signal that indicates the power consumption to which the power meter is coupled. In some scenarios, the power meter may be configured to convert the analog signal to a digital value that can be accessed and/or stored. Additionally, and/or alternatively, power management system 110 may retrieve information about power consumption from each of the multiple computing nodes, assess a power consumption pattern among the multiple computing nodes, and adjust the power budget rules for the multiple computing nodes. Power management system 110 may further transmit the updated power budget rules to each respective computing nodes, which in response, adjusts the power consumption of that computing node. Examples of processes that may be implemented in the power management system and each of the multiple computing nodes are additionally explained with reference to FIGS. 2-3. These processes may be implemented using executable programming instructions for performing actions described in those processes, executed by hardware of one or more computing nodes.

In FIG. 2, process 200 that may be implemented in each computing node (e.g., 104a-104d in FIG. 1) may include: receiving a respective power budget rule 202 for that computing node from the power management system (e.g., 110 in FIG. 1); monitoring and determining an instant power consumption on that node 204; comparing the instant power consumption with the power budget in the power budget rule 206; and determining whether a difference between the instant power consumption and the respective power budget has satisfied a criteria 208. In determining the difference, the process may retrieve and evaluate data that respectively represent the stored instant power consumption and the power budget. If the difference between the instant power consumption and the respective power budget has met the criteria, the process may adjust the power consumption of that computing node 210; otherwise, the process may proceed with operation and continue monitoring instant power consumption 204. For example, the criteria may include a condition that the difference between the instant power of the computing node and the power budget has reached below a threshold. The threshold may be, for example, 10%, which means that the power consumption on the computing node has reached 90% of its maximum power budget. In such case, the process may adjust the power consumption of the computing node.

In some examples, the computing node may have a processor. In adjusting the power consumption, the computing node may cause the processor to operate at a second power state that corresponds to a lower or higher power consumption. For example, the processor of a computing node may be configured to operate at various different power states. For example, a processor may be configured to operate at a core executing state (e.g., P0), in which the processor is executing programming instructions in a normal operation condition. These programming instructions may be executed to perform tasks assigned to the processor, e.g., user tasks, applications, the operating system, etc., that may be unrelated to the operation of the processor. When the difference between the instant power consumption and the power budget is less than 10% of the power budget, the computing node may cause the processor to operate at a power conserving state (e.g., p-state). In some or other examples, a processor may operate at various power conserving states from conserving state to more extensive conserving state that may be represented by various P states, e.g., from P1 to P2 to Pn, where n is a number that depends from CPU to CPU. For example, in one type of CPU, a maximum power conserving state Pn may be P6. In a non-limiting example, a computing node may be operating at a power conserving state, e.g., P1. Upon reaching near the power budget, the computing node may switch the processor to a more extensive power conserving state, e.g., P6 to conserve power. In some examples, lowering power consumption of a processor may include decreasing the operating frequency or voltage of the processor. A processor may be configured to correspond one or more tasks (e.g., user tasks, applications, operation system residing on the computing node etc.) to each of the power conserving states. For example, p-state may correspond to low-priority tasks, e.g., some user applications, while P0 state may correspond to higher-priority tasks, such as the operating system or processing of a voice call. In some examples, a processor may support an Advanced Configuration and Power Interface (ACPI) interface, and the computing node may use ACPI to set the states of the processor. For example, the computing node may execute a system function, which may be part of the operating system of the computing node, to set the power state of the processor via the ACPI interface.

With reference to FIG. 3, process 300 that may be implemented in the power management system, such as power management system (110 in FIG. 1) is further described in detail. Process 300 may include determining power budget rule(s) for one or more of the multiple computing nodes 302, and transmitting the power budget rule(s) to each respective computing node 304. In determining the power budget rule, in some scenarios, the process may determine an initial power budget rule that has an initial power budget for each of the computing nodes. For example, process 300 may determine the initial power budget based on the maximum power of the PDU. In some scenarios, the initial power budget may have a value that is the maximum power of the PDU divided by the number of computing nodes that are powered by that PDU. As not all computing nodes may reach its respective power budget at the same time, process 300 may set the initial power budget higher, for example, by increasing the value of the initial power budget by an amount, e.g., 10%, 20%, 30% etc.

In some scenarios, process 300 may also include determining the power budget rules for each respective computing node based on a power model of each computing node. The power model of each computing note may be obtained via training, for example. The power model may in some examples be known in advance and obtained, for example, from the provider of each computing node. In other scenarios, process 300 may update the power budget rules for each of the multiple computing nodes iteratively based on a power consumption pattern or other factors.

With continued reference to FIG. 3, process 300 may update the power budget rules of multiple computing nodes 314. In updating the power budget rules, the process may determine a revised value of the power budget rules, e.g., an updated power budget. In a non-limiting example, the process may write one or more data blocks with one or more values that represent the revised power budget. Process 30 may also transmit the updated power budget rules to the computing nodes 304, for example, by transmitting one or more data packets that represent the revised values of the power budget. The process may update the power budget rules based on various factors. For example, process 300 may assess the power consumptions of the multiple computing nodes 306. In a non-limiting example, process 300 may receive a respective power consumption from one or more of the multiple computing nodes, for example, via an input/output peripheral of each respective computing node or a communication link. The process may assess the received power consumptions of the one or more of the multiple computing nodes, and update a respective power budget rule for each of the multiple computing nodes 314 based on the assessment. In some scenarios, the power consumption may be represented by one or more data blocks transmitted from the one or more computing nodes for the power management system to assess.

In a non-limiting example, power management system may assess the power consumptions (e.g., an instant power consumption or an average power consumption during a period of time) of the one or more of the multiple computing nodes on the network to determine whether the power consumptions among the multiple computing nodes that share the same PDU(s) are properly balanced. For example, one of the multiple computing nodes may operate at high power consumption that is close to the power budget (e.g., the difference between the power consumption of the computing node and the power budget of the same computing node is below a threshold, such as 10% of the power budget) while another computing node runs at low power consumption (e.g., the difference between the power consumption of the computing node and the power budget of the same computing node is exceeding a threshold, such as 60% of the power budget). In the instant example, the low power consumption computing node consumes only 40% of the power budget while the high power consumption computing node consumes 90% of the power budget. In such case, process 300 may adjust each of the high power consumption computing node and the low power consumption computing node. For example, the process may increase the power budget of the high power consumption computing node. Alternatively, and/or additionally, process 300 may decrease the power budget of the low power consumption computing node.

In some scenarios, a cluster in a network may include one or more computing nodes and each cluster is powered by a PDU. Process 300 may determine a power budget rule for each cluster, and monitor the power consumption on a per cluster basis. For example, process 300 may determine an aggregated power consumption among all computing nodes in a cluster, compare the aggregated power consumption against a power budget for that cluster, and update the power budget rule for each computing nodes. For example, if the aggregated power consumption among the multiple computing nodes in a cluster is approaching the power budget for the cluster, process 300 may determine to decrease the power budget for one or more computing nodes.

Alternatively, and/or additionally, process 300 may determine priorities of workloads in one or more computing nodes 308, and update the power budget rules based on the priorities of workloads in one or more computing nodes. For example, the priority of workloads in a first computing node may be higher than that in a second computing node. In such case, process 300 may adjust the power budget for the first computing node to be higher than that for the second computing node. As a result, the workloads in the first computing node may be guaranteed to run at full power consumption mode. On the other hand, the computing nodes that do not have high priority workloads may give away power budget to those computing nodes having higher priorities of workloads. In some scenarios, the priorities of workloads for each computing nodes may be known or assigned in advance. In a non-limiting example, a computing node in a data center may be designated to perform computations in critical tasks, such as handling a voice call in a cellular communication network, and thus may have a higher priority of workloads in that computing node. In another non-limiting example, a user of a computing node may upload a task that requires higher priority to the computing node. Process 300 may communicate with each computing node to obtain a priority of workloads on that computing node.

Alternatively, and/or additionally, process 300 may determine the actual computation load of each computing node 310 and update the power budget rule(s) 314 for the multiple computing nodes based on the computation loads of the computing nodes. For example, process 300 may include determining the computation load associated with a computing node via an IO peripheral of the computing node by monitoring the data flow in the IO peripheral. In other examples, process 300 may receive the computation load associated with the computing node directly from that computing node via a communication link, such as a wireless communication. In updating the power budget rule(s) 314, process 300 may adjust the computing node with higher computation loads by increasing the power budget for that node. Alternatively, process 300 may adjust the computing node with lower computation loads by decreasing the power budget for that node. For example, if a computing node that handles voice calls in a cellular communication network abnormally gets a high volume of calls that cause the computing node to operate with higher computation loads, the power management system may increase the power budget for that computing node, where possible (or without compromising the performance of other computing nodes).

Alternatively, and/or additionally, process 300 may determine a power consumption pattern among multiple computing nodes 312, and update the power budget rule(s) 314 for the multiple computing nodes based on the power consumption pattern. For example, process 300 may determine actual power consumptions for each computing node and determine a power consumption pattern based on the actual power consumptions. In some scenarios, the process may include using a machine learning technique to train a power budget model of the computing system based on a set of training data. The training data may include the past power consumptions of each computing node, how busy each computing node is, and/or utilization of the processor (e.g., computing central unit (CPU)) for each computing node. The trained power budget model may include the power consumption pattern, the busyness of each computing node, e.g., given a period of time, and/or processor utilization pattern of each computing node. Process 300 may use the power budget model to update the power budget rules for each respective computing node. In a non-limiting example, the power budget model may indicate that a particular computing node runs busy in the afternoons. For example, the computing node handling voice calls may usually get frequent calls during the afternoons. In such case, process 300 may automatically increase the power budget for that computing node during afternoon hours, anticipating a higher power consumption.

In updating the power budget rule(s) 314, blocks 306, 308, 310 and 320 may be implemented alone or in combination. For example, process 300 may determine that an aggregated power consumption from multiple computing nodes on the same PDU is approaching the maximum power limit for that PDU, then process 300 may adjust the power budget for each of the multiple computing nodes based on the priorities of workload of each computing node. For example, process 300 may increase the power budget of the computing node that has a higher workload priority and decrease the power budget of the computing node that has a lower workload priority. As a result, the aggregated power consumption for the multiple computing nodes may advantageously be prevented from continuing to increase to trip the circuit or cause the breakdown of the PDU that powers the computing nodes. Alternatively, and/or additionally, each computing node may include a power sensor, a voltage regulator, a hot-swap controller and/or a management controller that may be configured to control the power consumption based on the power budget for that computing node.

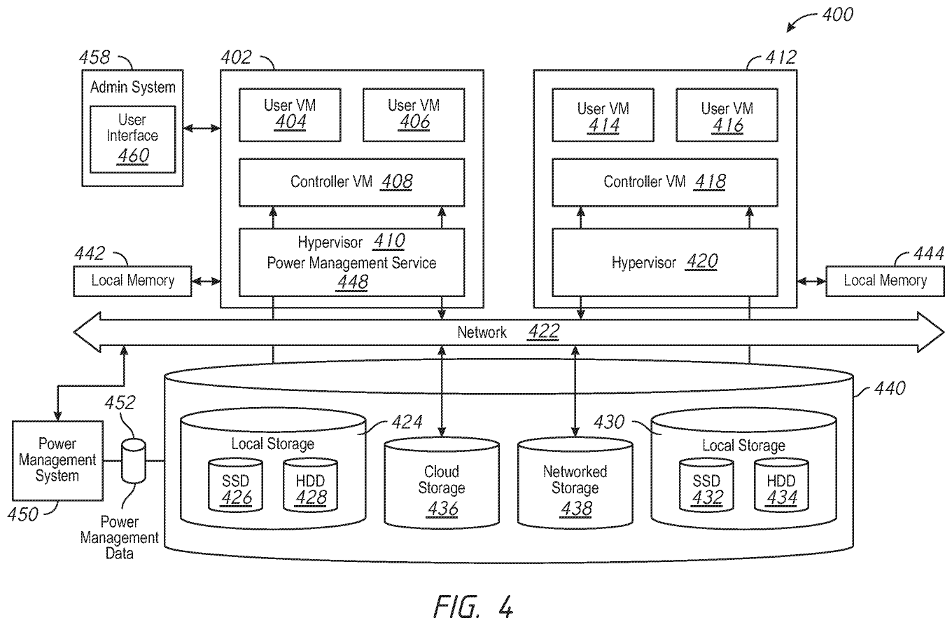

In some examples, various embodiments described in FIGS. 1-3 can be implemented in a hyper-converged computing system. In FIG. 4, a hyper-converged computing system 400 may include multiple computing nodes 402, 412, and storage 440, all of which may be in communication with a network 422. The network 422 may be any type of network capable of routing data transmissions from one network device (e.g., computing node 402, computing node 412, and storage 440) to another. Network 422 may include wired or wireless communication links.

The storage 440 may include local storage 424, local storage 430, cloud storage 436, and networked storage 438. The local storage 424 may include, for example, one or more solid state drives (SSD 426) and one or more hard disk drives (HDD 428). Similarly, local storage 430 may include SSI) 432 and HDD 434. Local storage 424 and local storage 430 may be directly coupled to, included in, and/or accessible by a respective computing node 402 and/or computing node 412 without communicating via the network 422. Other nodes, however, may access the local storage 424 and/or the local storage 430 using the network 422. Cloud storage 436 may include one or more storage servers that may be stored remotely to the computing node 402 and/or computing node 412 and accessed via the network 422. The cloud storage 436 may generally include any suitable type of storage device, such as HDDs SSDs, or optical drives. Networked storage 438 may include one or more storage devices coupled to and accessed via the network 422. The networked storage 438 may generally include any suitable type of storage device, such as HDDs SSDs, and/or NVM Express (NVMe). In various examples, the networked storage 438 may be a storage area network (SAN). Any storage in storage 440 may contain power management data 452, which includes various data that may be accessed by a power management system 450. In some examples, power management data 452 may include block(s) of data representing respective power budgets for each of the computing nodes 402, 412. Power management data 452 may also include data representing power consumptions of each computing node that are to be used by the power management system 450 to update respective power budget rules for each computing node.

With continued reference to FIG. 4, computing nodes 402, 412 may include, for example, a server 104a-104d in data center 102b (FIG. 1), or a server in any data center on the network (e.g., 120 in FIG. 1). The computer node 402 may be configured to implement the power management system, e.g., 110 in FIG. 1. In some scenarios, the computing node 402, 412 may include a computing device for hosting virtual machines (VMs) in the hyper-converged computing system of FIG. 4. For example, computing node 402 may be configured to execute a hypervisor 410, a controller VM (CVM) 408 and one or more user VMs, such as user VMs 404, 406. The user VMs, including user VM 404 and user VM 406, are virtual machine instances executing on the computing node 402. The user VMs may share a virtualized pool of physical computing resources such as physical processors and storage (e.g., storage 440). The user VMs may each have their own operating system, such as Windows or Linux. While a certain number of user VMs are shown, generally any suitable number may be implemented. User VMs may generally be provided to execute any number of applications which may be desired by a user.

Hypervisor 410 may implement certain functions performed in computing node 402. For example, hypervisor 410 may include a power management service 448. Power management service 448 may be configured to receive a respective power budget rule from the power management system for computing node 402 in which the power management service 448 is residing. Power management service 448 may also determine an instant power consumption in the computing node 402, compare the instant power consumption with the power budget in the power budget rule, and determine whether a difference between the instant power consumption and the respective power budget has satisfied a criteria. Similar to embodiments described with reference to FIG. 2, if the difference between the instant power consumption and the respective power budget has met the criteria, the computing node may adjust the power consumption of that computing node; otherwise, the computing node may proceed with operation and continue monitoring the instant power consumption.

In some examples, computing node 402 may have a processor. In adjusting the power consumption, hypervisor 410 may cause the processor to operate at a power state that corresponds to a higher or lower power consumption. This process has been described in various embodiments with reference to FIG. 2. For example, hypervisor 410 may be configured to receive the power budget from the power management system (e.g., 110 in FIG. 1, 450 in FIG. 4), execute various processes described in FIG. 2, and communicate with the processor. In a non-limiting example, hypervisor 410 may communicate with the processor via a firmware, e.g., basic input and output system (BIOS) of the operating system on the computer node. In another non-limiting example, hypervisor 410 may communicate directly with the processor via an interface, e.g., ACPI.

Hypervisor 410 may be of any suitable type of hypervisor. For example, hypervisor 410 may be ESX, ESX(i), Hyper-V, KVM, or any other type of hypervisor. Hypervisor 410 may manage the allocation of physical resources (such as storage 440 and physical processors) to VMs (e.g., user VM 404, user VM 406, and controller VM 408) and perform various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

With continued reference to FIG. 4, in some scenarios, computing node 402, 412 may also include CVMs described herein, such as the controller VM 408 and/or controller VM 418, which may provide services for the user VMs in the computing nodes. As an example, CVM 408 may implement certain processes described with reference to FIG. 2. For example, in adjusting power consumption of the computing node (block 210 in FIG. 2), CVM 408 may communicate with the processor in the computing node 402 to cause the processor to operate at a power state that corresponds to a lower or higher power consumption. For example, the processor of a computing node may be operating at a core executing state (e.g., P0), in which the core is executing instructions. When the power consumption of a computing node is approaching its power budget (e.g., when the difference between the instant power consumption of the computing node and the power budget for that computing node is less than 10% of the power budget), the computing node may cause the processor to operate at a power conserving state (e.g., p-state). In some or other examples, a processor may operate at various power conserving states from conserving state to more extensive conserving state, e.g., from P1 to P2 to Pn, where n depends from CPU to CPU. In a non-limiting example, a computing node may be operating at a power conserving state, e.g., P1. Upon approaching the power budget for that computing node, the computing node may switch the processor to a more extensive power conserving state, e.g., P6 to conserve power.

In some examples, CVM 408 may communicate with any VMs 404, 406 to cause a processor to operate at a lower or higher power consumption state. In some scenarios, CVM 408 may directly communicate with a processor via an ACPI interface to set the states of the processor.

Hypervisor 410 may communicate with CVM described herein using Internet protocol (IP) requests. In some examples, CVM 408 and hypervisor 410 may each implement certain functions in various embodiments with reference to FIG. 2. For example, hypervisor 410 may be configured to perform blocks 202, 204, 206, and 208, whereas CVM 408 performs block 210 (in FIG. 2). Computing node 412 may have a similar structure as that in computing node 402. In some scenarios, CVM 408 and CVM 418 may communicate with one another via the network 422.

Controller VMs, such as CVM 408 and CVM 418, may each execute a variety of services and may coordinate, for example, through communication over network 422. Services running on controller VMs may utilize an amount of local memory to support their operations. For example, services running on CVM 408 may utilize memory in local memory 442. Services running on CVM 418 may utilize memory in local memory 444. The local memory 442 and local memory 444 may be shared by VMs on computing node 402 and computing node 412, respectively, and the use of local memory 442 and/or local memory 444 may be controlled by hypervisor 410 and hypervisor 420, respectively. Moreover, multiple instances of the same service may be running throughout the hyper-converged system, e.g., a same services stack may be operating on each controller VM. For example, an instance of a service may be running on CVM 408 and a second instance of the service may be running on CVM 418.

Note that controller VMs are provided as virtual machines utilizing hypervisors described herein, for example, CVM 408 is provided behind hypervisor 410. The controller VMs that run “above” the hypervisors in the examples described herein may be implemented within any virtual machine architecture, since the controller VMs may be used in conjunction with generally any hypervisor from any virtualization vendor.

Examples of controller VMs described herein may provide a variety of services (e.g., may include computer-executable instructions for providing services). Examples of services are described herein, such as power management service 448 of FIG. 4. A single power management service 448 is shown in FIG. 4, although multiple controller VMs in a system may provide power management services (e.g., the controller VM 418 may also have a power management service). In some examples, one instance of the power management service (e.g., power management service 448) may serve as a “lead” service and may provide coordination and/or management of the service across a system (e.g., across a cluster). In sonic scenarios, power management service 448 may communicate with other power management services. For example, a first power management service associated with a first CVM in a first computing node may receive power budget rules for the first computing node and/or, additionally, the power budget rule for a second computing node. The first power management service may communicate the corresponding power budget rules to a second. power management service associated with a second controller VM in the second computing node. As power manage service can be implemented in a hypervisor or a CVM, hypervisor 410 may communicate with CVM 408 described herein using Internet protocol (IP) requests. A hypervisor in one computing node may also communicate with other hypervisors in other computing nodes, e.g., via the network 422.

Examples of systems described herein may include one or more administrator systems, such as admin system 458 of FIG. 4. The administrator system may be implemented using, for example, one or more computers, servers, laptops, desktops, tablets, mobile phones, or other computing systems. In some examples, the admin system 458 may be wholly and/or partially implemented using one of the computing nodes of a hyper-converged computing system described herein. However, in some examples (such as shown in FIG. 4), the admin system 458 may be a different computing system from the virtualized system and may be in communication with a CVM of the virtualized system (e.g., controller VM 408 of FIG. 4) using a wired or wireless connection (e.g., over a network).

Administrator systems described herein may host one or more user interfaces, e.g., user interface 460. The user interface may be implemented, for example, by displaying a user interface on a display of the administrator system. The user interface may receive input from one or more users (e.g., administrators) using one or more input device(s) of the administrator system, such as, but not limited to, a keyboard, mouse, touchscreen, and/or voice input. The user interface 460 may provide input to controller VM 408 and/or may receive data from the controller VM 408 (e.g., from the power management service 448). For example, a user may set the priority of workload in a computing node by transmitting a value that indicates the priority of workload to the controller VM residing in that computing node. The user interface 460 may be implemented, for example, using a web service provided by the controller VM 408 or one or more other controller VMs described herein. In some examples, the user interface 460 may be implemented using a web service provided by controller VM 408 and information from controller VM 408 (e.g., from power management service 448) may be provided to admin system 458 for display in the user interface 460.

Administrator systems may have access to (e.g., receive data from and/or provide data to) any number of clusters of one or more computing nodes, including a single cluster or multiple clusters. In the example of FIG. 4, the admin system 458 may receive data, such as power consumption of a computing node, from the power management service 448 about the instant power consumption of that computing node.

With further reference to FIG. 4, the hyper-converged computing system 400 may also include a power management system 450. Power management system 450 may be in communication with one or more computing nodes 402, 412 in the system via network 422. Power management system 450 may also have access to the power management data 452 in performing various functions. Power management data 452 may include a local storage to the power management system 450, or belong to any of the computing nodes 402, 412 in the system 400 or the network 422, and can be accessed by the power management system 450. For example, power management data 452 may include any storage components in storage 440, such as local storage, cloud storage and/or networked storage that belong to one or more computing nodes 402, 412 in the system 400. In some scenarios, power management system 450 may include a server on the network 422 and many communicate with one or more computing nodes, or one or more components of each computing nodes, e.g., a hypervisor or a CVM, on the network. In other scenarios, power management system 450 itself may be implemented on a CVM, e.g., CVM 408, and communicate with CVMs or hypervisors in other computing nodes on the network. Power management system 450 may implement various processes described herein with reference to FIG. 3.

In a non-limiting example, power management system 450 may be configured to determine power budget rule(s) for one or more of the multiple computing nodes, e.g., 402, 412, and transmit the power budget rule(s) to each respective computing node 402, 412. For example, power management system 450 may communicate with a CVM residing in each computing node 402, 412 and transmit the respective power budget rule to that computing node. In determining the power budget rule, in some scenarios, power management system 450 may determine an initial power budget rule for all of the computing nodes. For example, the initial power budget rule may include an initial power budget based on the maximum power of the PDU. In some scenarios, the initial power budget may be the maximum power of the PDU divided by the number of computing nodes that are connected to the PDU. As not all computing nodes may reach its respective power budget at the same time, power management system 450 may set the initial power budget for each computing node higher, for example, by increasing the initial power budget by an amount, e.g., by 10%, 20%, 30% etc.

In some scenarios, power management system 450 may determine the power budget rules for each respective computing node based on a power model of each computing node. The power model of each computing note may be obtained via a training, for example. The power model may also be known and obtained from the provider of each computing node. In other scenarios, power management system 450 may determine or update power budget rules for each of the multiple computing nodes iteratively based on a power consumption pattern or other factors.

In some examples, power management system 450 may update each respective power budget rule for one or more of the multiple computing nodes and transmit the updated power budget rules to the respective computing nodes. For example, power management system 450 may determine to update power budget rules for one or more of the multiple computing nodes while the power budget rules for other computing nodes remain unchanged. In such case, the power management system 450 may transmit the updated power budget rules only to those computing nodes.

Power management system 450 may update the power budget rules based on various factors. In a non-limiting example, power management system 450 may assess the power consumptions of the multiple computing nodes 402, 412. In a non-limiting example, power management system 450 may receive the respective power consumption from one or more of the multiple computing nodes. For example, power management system 450 may communicate or monitor the activities of each computing node via an I/O peripheral of each respective computing node. Power management system 450 may also communicate with a computing node via a communication link between the computing node and the power management system. In some examples, power management system 450 may also communicate with certain components of a computing node, e.g., the power management service in a hyperviser or a CVM. In some scenarios, a hyperviser or a CVM in each computing node may be configured to transmit certain provisioning and status data associated with that computing node to the power management system 450.

In some scenarios, power management system 450 may directly communicate with a computing node to receive certain provisioning and status data of that computing node. For example, power management system 450 may communicate with a computing node and determine the actual power consumption of that computing node. The power management system 450 may assess the power consumptions of one or more computing nodes, and update the respective power budget rule for each of the multiple computing nodes based on the assessment. For example, power management system may determine whether the power consumptions among the multiple computing nodes that share the same PDU(s) are properly balanced. In some scenarios, some computing nodes may have a high power consumption while others may have a low power consumption. In such a case, the power management system 450 may be configured to adjust each of the high power consumption computing node and the low power consumption computing node. For example, power management system 450 may increase the power budget of the high power consumption computing node so that the computing node may continue operating. Alternatively, and/or additionally, power management system 450 may decrease the power budget of the low power consumption computing node to allocate some power budget to the other computing nodes.

In some examples, the power management system 450 may evaluate the power consumptions of all high power consumption computing nodes whose power consumptions are approaching respective power budgets, and increase the power budgets for these computing nodes by an amount. For example, the power management system 450 may increase the power budgets for those computing nodes by 10%, 20% or a variable amount. In some scenarios, the variable amount may be based on how close the power consumption is to the power budget. For example, the variable amount may be disproportional to the difference between the power consumption and the power budget. In a non-limiting example, if the power consumption of a computing node has reached 90% of the power budget for that node, the power management system 450 may determine to increase the power budget by 10%. If the power consumption has reached 95%, the power management system may increase the power budget by 15%; if the power consumption has reached 85% of the power budget, the power management system may increase the power budget by 5%, etc. The power management system 450 may also add all increase amount among the computing nodes to determine an aggregated increase amount.

In some scenarios, the power management system 450 may also determine that certain computing nodes that are underutilized, where the power consumptions for those computing nodes are significantly below each respective power budget, for example, the power consumption is at 60%, 50% or lower of each node's power budget. In some examples, the power management system 450 may decrease the power budgets for these nodes by an amount. For example, the decrease amount may be determined based on how much these computing nodes are underutilized and determine the decrease amount in proportional to the difference between the power consumption and the power budget. In a non-limiting example, if the power consumption of a computing node has reached 50% of the power budget for that node, the power management system 450 may determine to decrease the power budget by 20%. If the power consumption has reached 40%, the power management system may decrease the power budget by 30%; if the power consumption has reached 60% of the power budget, the power management system may decrease the power budget by 10%, etc. The power management system 450 may also add all decrease amount among the computing nodes to determine an aggregated decrease amount.

In some scenarios, the power management system may evaluate an aggregated increase amount against an aggregated decrease amount and determine whether the increase amount in power budgets can be sufficiently made up by the decrease amount. For example, if the aggregated increase amount in the power budgets is totaled 500 watts and the aggregated decrease amount is above the aggregated increase amount, e.g., 600 watts, then the power management system will update the power budgets by the increase or decrease amount for certain computing nodes. In another example, if the aggregated increase amount in the power budgets is larger than the aggregated decrease amount, it means that the extra power budget to re-allocate from underutilized computing nodes may not be enough to make up the increase in power budgets of high power consumption nodes. In that case, the power management system 450 may reduce the increase amount or may enlarge the decrease amount so that the aggregated increase amount may be equal or less than the aggregated decrease amount.

Alternatively, and/or additionally, power management system 450 may communicate with each computing node to receive a workload priority from that computing node. In some scenarios, the priorities of workloads for each computing nodes may be known in advance. Power management system 450 may update the power budget rules based on the priorities of the workloads in each computing node. For example, the priority of workloads on a first computing node may be higher than that on a second computing node. In such case, power management system 450 may adjust the power budget for the first computing node to be higher than that for the second computing node. As a result, the higher priority workloads on the first computing node may be more likely and/or guaranteed to run at full power consumption mode. On the other hand, the computing nodes that do not have higher priority workloads may give away power budget to higher priority workloads on other computing nodes.

In some scenarios, the priority of workloads may be represented by one or more data values. For example, the priority of workloads for a computing node may include a single value data. In one example, the higher the value the higher the priority is. In some scenarios, the power management system 450 may update the power budget for a computing node based on the priorities of workloads. Alternatively, and/or additionally, power management system 450 may also update power budgets based on a combination of priorities of workloads and other factors. For example, power management system 450 may update power budgets for certain computing nodes based on a combination of power consumptions and priorities of workloads for those computing nodes. For example, when the power management system 450 determines that the power consumption for a computing node is approaching its power budget, the power management system 450 may determine the increase amount in the power budget based on the priority of workloads in that computing node. For example, if the priority of workloads for a computing node has a high value, the power management system 450 may set the increase amount at a higher value so that the computing node will be less likely to hit the power budget. On the other hand, if the priority of workloads for a computing node has a low value, the power management system 450 may set the increase amount for that computing node at a lower value.

Alternatively, and/or additionally, power management system 450 may determine the actual computation loads of one or more computing nodes and update the power budget rule(s) for one or more computing nodes based on the actual computation loads. In some scenarios, power management system 450 may determine the computation load associated with the computing node via an IO peripheral of the computing node by monitoring the data flow in the IO peripheral. In other examples, power management system 450 may communicate with each computing node to receive the computation load associated with that computing node. In updating the power budget rule(s), power management system 450 may adjust the power budget rule for the computing node with higher computation loads by increasing the power budget for that node. Alternatively, power management system 450 may adjust the power budget for the computing node with lower computation loads by decreasing the power budget for that node. For example, if a computing node that handles voice calls in a cellular communication network abnormally gets high volume calls that cause the computing node to operate with higher computation loads, power management system 450 may increase the power budget for that computing node, where possible (or without compromising the performance of other computing nodes).

In some scenarios, a cluster in a network may include one or more computing nodes and the computing nodes in that cluster are powered by a PDU. Power management system 450 may determine a power budget rule for each cluster, and monitor the power consumption on a per cluster basis. For example, power management system 450 may determine an aggregated power consumption among all computing nodes in a duster, compare the aggregated power consumption against a power budget for that cluster, and update power budget rule(s) for each respective computing nodes in that cluster. For example, if the aggregated power consumptions among multiple computing nodes is approaching the power budget for the cluster, power management system 450 may determine to decrease the power budget for one or more computing nodes.

Alternatively, and/or additionally, power management system 450 may determine a power consumption pattern among the multiple computing nodes, and update the power budget rule(s) for one or more computing nodes based on the power consumption pattern. For example, power management system 450 may use a machine learning technique to train a power budget model based on a set of training data. The training data may include the past power consumptions of one or more computing node, how busy each computing node is, and/or utilization of the processor (e.g., computing central unit (CPU)) for each computing node. The trained power budget model may include the power consumption pattern, the busyness of each computing node, e.g., given a period of time, and/or processor utilization pattern of each computing node. Power management system 450 may use the trained power budget model to update the power budget rules for each respective computing node.

Similar to what is described herein with reference to FIG. 3, power management system 450 may receive one or more provisioning or status of each computing node and update the power budget rule(s) based on the received provisioning or status. For example, power management system 450 may receive power consumption values from one or more computing nodes, and determine that an aggregated power consumption from multiple computing nodes on the same PDU is approaching the maximum power limit for that PDU. In response, power management system 450 may adjust the power budget for each of the multiple computing nodes based on the priorities of workload of each computing node, and/or based on the power consumption pattern obtained from the training. For example, power management system 450 may increase the power budget of the computing node that has a higher workload priority and decrease the power budget of the computing node that has a lower workload priority. Alternatively, and/or additionally, power management system 450 may increase the power budget for a computing node that is anticipated (based on a power consumption pattern) to have higher power consumption, and may decrease the power budget for the computing node that is anticipated to have lower power consumption.

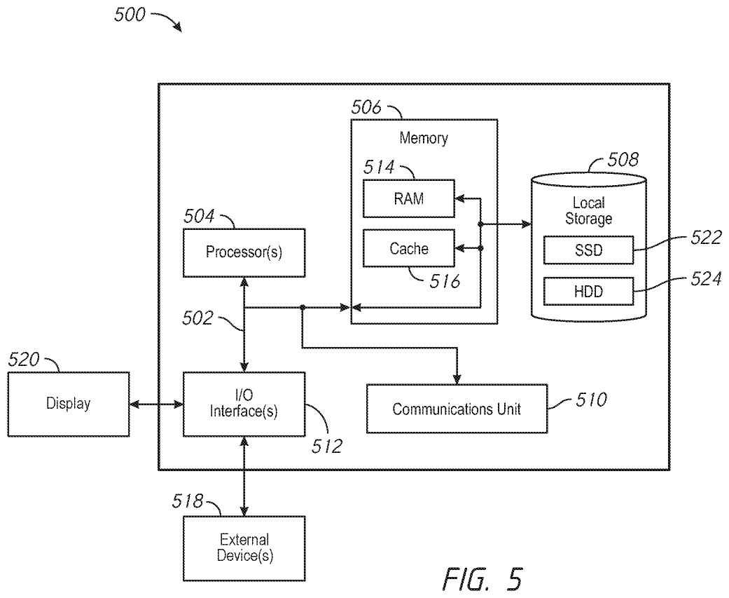

FIG. 5 depicts a block diagram of components of a computing node (e.g., 102a-102d in FIG. 1, 402, 412 in FIG. 4) or the power management system (e.g., 110 in FIG. 1, or 450 in FIG. 4) in accordance with examples described herein. It should be appreciated that FIG. 5 provides only an illustration of one implementation and does not imply any limitations with regard to the environments in which different embodiments may be implemented. Many modifications to the depicted environment may be made.

In FIG. 5, the computing node or power management system 500 may include a communications fabric 502, which provides communications between one or more processor(s) 504, memory 506, local storage 508, communications unit 510, I/O interface(s) 512. The communications fabric 502 can be implemented with any architecture designed for passing data and/or control information between processors (such as microprocessors, communications and network processors, etc.), system memory, peripheral devices, and any other hardware components within a system. For example, the communications fabric 502 can be implemented with one or more buses.

The memory 506 and the local storage 508 are computer-readable storage media. In this embodiment, the memory 506 includes random access memory RAM 514 and cache 516. In general, the memory 506 can include any suitable volatile or non-volatile computer-readable storage media. The local storage 508 may be implemented as described above with respect to local storage 424 and/or local storage 430 (in FIG. 4). In this embodiment, the local storage 508 includes an SSD 522 and an HDD 524, which may be implemented as described above with respect to SSD 426, SSD 432 and HDD 428, HDD 434 respectively.

Various computer instructions, programs, files, images, etc. may be stored in local storage 508 for execution by one or more of the respective processor(s) 504 via one or more memories of memory 506. In some examples, local storage 508 includes a magnetic HDD 524. Alternatively, or in addition to a magnetic hard disk drive, local storage 508 may include the SSD 522, a semiconductor storage device, a read-only memory (ROM), an erasable programmable read-only memory (EPROM), a flash memory, or any other computer-readable storage media that is capable of storing program instructions or digital information.

The media used by local storage 508 may also be removable. For example, a removable hard drive may be used for local storage 508. Other examples include optical and magnetic disks, thumb drives, and smart cards that are inserted into a drive for transfer onto another computer-readable storage medium that is also part of local storage 508.

Communications unit 510, in these examples, provides for communications with other data processing systems or devices. In these examples, communications unit 510 includes one or more network interface cards. Communications unit 510 may provide communications through the use of either or both physical and wireless communications links.

I/O interface(s) 512 allows for input and output of data with other devices that may be connected to computing node 500. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks, and memory cards. Software and data used to practice embodiments of the present invention can be stored on such portable computer-readable storage media and can be loaded onto local storage 508 via I/O interface(s) 512. I/O interface(s) 512 also connect to a display 520. Display 520 provides a mechanism to display data to a user and may be, for example, a computer monitor.

From the foregoing it will be appreciated that, although specific embodiments have been described herein for purposes of illustration, various modifications may be made while remaining with the scope of the claimed technology. Further, various embodiments disclosed herein with reference to FIGS. 1-5 provide advantages in multiple ways. For example, by the power management system updating the power budget rules, each computing node in the system may run to its full extend whereas computing nodes with low power consumption will operate without wasting power allocation for the system. For example, the power management system may monitor the power consumption in each computing node and dynamically update the power budget for each computing node by increasing the power budget for high power consumption computing node and lower the power budget for low power consumption computing node. This power re-allocation helps the high power consumption nodes to continue running with a reduced risk of power outage in the data center outage or without duplicating the power supplies.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. 10651 Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition 13 without departing from the scope of the present disclosure. In other words, as used herein, the phrase “based on” shall be construed in the same manner as the phrase “based at least in part on.”

From the foregoing it will be appreciated that, although specific embodiments of the present disclosure have been described herein for purposes of illustration, various modifications may be made without deviating from the spirit and scope of the present disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A system comprising:
multiple computing nodes, each having a processor configured to operate at least a first power state, a hypervisor, and multiple virtual machines including a controller virtual machine; and
a power management system configured to: <determine a respective power budget rule for each of the multiple computing nodes, each respective power budget rule comprising a power budget; and
transmit to each of the multiple computing nodes the respective power budget rule;
wherein each of the multiple computing nodes is configured to:
receive the respective power budget rule;
determine an instant power consumption;
determine whether a difference between the instant power consumption and the respective power budget has satisfied a criteria; and
if the difference between the instant power consumption and the respective power budget has satisfied the criteria, adjust power consumption of the computing node.

2. The system of claim 1, wherein each of the multiple computing nodes is configured to adjust the power consumption by causing the processor to operate at a second power state that corresponds to a lower power consumption than power consumption of the first power state.

3. The system of claim 2, wherein the first power state is a core executing state and the second power state is a power conserving state.

4. The system of claim 1, wherein:
each of the multiple computing nodes is further configured to transmit a power consumption to the power management system; and
the power management system is further configured to:
receive power consumptions from one or more of the multiple computing nodes;
assess the power consumptions of the one or more of the multiple computing nodes;
based on the assessment, update the respective power budget rule for each of the multiple computing nodes; and
transmit the updated respective power budget rule to each of the multiple computing nodes.

5. The system of claim 4, wherein the power management system is configured to update the respective power budget rule for each of the multiple computing nodes by:
increasing the power budget of the respective power budget rule if a difference between the power budget and a respective power consumption associated with the computing node is less than a first threshold.

6. The system of claim 4, wherein the power management system is configured to update the respective power budget rule for each of the multiple computing nodes by:
decreasing the power budget of the respective power budget rule if a difference between the power budget and a respective power consumption associated with the computing node has exceeded a second threshold.

7. The system of claim 4, wherein the power management system is configured to update the respective power budget rule for each of the multiple computing nodes based on computation loads associated with one or more of the multiple computing nodes.

8. The system of claim 7, wherein the power management system is configured to determine the computation loads associated with the one or more computing nodes via an IO peripheral of each of the one or more computing nodes.

9. The system of claim 7, wherein the power management system is configured to receive the computation loads associated with the one or more computing nodes by communicating with each of the one or more computing nodes.

10. The system of claim 4, wherein the power management system is configured to:
receive a priority of workload from at least one of the multiple computing nodes; and
update the respective power budget rule for the multiple computing nodes additionally based on the priority of workload.

11. The system of claim 4, wherein the power management system is configured to:
determine a power consumption pattern based on the power consumptions of the one or more of the multiple computing nodes; and
update the power budget rule for at least one of the multiple computing nodes based on the power consumption pattern.

12. A computing node in a computing system, the computing node comprising:
a processor configured to operate at least a first power state and configured to:
receive a power budget rule comprising a power budget from a power management in the computing system;
determine an instant power consumption;
determine whether a difference between the instant power consumption and the power budget has satisfied a criteria; and
if the difference between the instant power consumption and the power budget has satisfied the criteria, adjust power consumption of the computing node.

13. The computing node of claim 12, wherein the computing node is configured to adjust the power consumption by causing the processor to operate at a second power state that corresponds to a lower power consumption than power consumption of the first power state.

14. The computing node of claim 13, wherein the first power state is a core executing state and the second power state is a power conserving state.

15. The computing node of claim 12, wherein the processor is further configured to: transmit a power consumption to the power management system; and
receive an updated power consumption rule from the power management system which determines the updated power consumption rule based at least on the transmitted power consumption.

16. The computing node of claim 12 is further configured to:
transmit a priority of workload associated with the computing node to the power management system; and
receive an updated power budget rule from the power management system that determines the updated power budget rule based at least on the priority of workload.

17. The computing node of claim 16 is further configured to determine the priority of workload via a user interface.

18. A method comprising:
by a power management system in a computing system:
determining a respective power budget rule for each of multiple computing nodes in the computing system, each respective power budget rule comprising a power budget; and
transmitting to each of the multiple computing nodes the respective power budget rule; and
by each of the multiple computing nodes:
receiving the respective power budget rule;
determining an instant power consumption;
determining whether a difference between the instant power consumption and the respective power budget has satisfied a criteria; and
if the difference between the instant power consumption and the respective power budget has satisfied the criteria, adjusting power consumption of the computing node.

19. The method of claim 18, wherein adjusting the power consumption comprises causing a processor associated with one of the multiple computing nodes to switch operation from a first power state to a second power state, wherein the first power state and the second power state correspond to different power consumptions.

20. The method of claim 18 further comprising, by the power management system:
assessing power consumptions of one or more of the multiple computing nodes;
based on the assessment, updating the respective power budget rule for each of the multiple computing nodes; and
transmitting the updated respective power budget rule to each of the multiple computing nodes.
